(19) United States
(12) Patent Application Publication
(10) Pub. No.: US 2014/0098405 A1
(43) Pub. Date: Apr. 10, 2014

(54) PRINTING INSTRUCTION APPARATUS, PRINTING APPARATUS, AND PRINTING INSTRUCTION METHOD

(71) Applicant: FUJI XEROX CO., LTD., Tokyo (JP)

(72) Inventor: Shigeru AWANO, Yokohama-shi (JP)

(21) Appl. No.: 13/917,062

(22) Filed: Jun. 13, 2013

(30) Foreign Application Priority Data
Oct. 4, 2012 (JP) 2012-222490

(51) Int. Cl. G06K 15/02

(52) U.S. Cl. CPC G06K 15/1807
USPC 358/2.1

(57) ABSTRACT

There is provided a printing instruction apparatus. An acquiring unit acquires document data of a document to be printed. A receiving unit receives printing conditions set for each of types of document components included in the document. A setting unit performs printing setting for each of the types of the document components with respect to the document data, in response to a reception of the printing conditions. An instructing unit instructs a printing mechanism to perform printing based on the document data subjected to the printing setting.

### CROSS-REFERENCE TO RELATED APPLICATIONS

This application is based on and claims priority under 35 U.S.C. §119 from Japanese Patent Application No. 2012-222490 filed on Oct. 4, 2012.

### TECHNICAL FIELD

The present invention relates to a printing instruction apparatus, a printing apparatus, and a printing instruction method.

### SUMMARY

According to an aspect of the exemplary embodiments of the present invention, there is provided a printing instruction apparatus comprising: an acquiring unit that acquires document data of a document to be printed; a receiving unit that receives printing conditions set by a user for each of types of document components included in the document; a setting unit that performs printing setting for each of the types of the document components with respect to the document data acquired by the acquiring unit, in response to a reception of the printing conditions by the receiving unit; and an instructing unit that instructs a printing mechanism to perform printing based on the document data subjected to the printing setting by the setting unit.

### BRIEF DESCRIPTION OF THE DRAWINGS

Exemplary embodiments of the present invention will be described in detailed based on the following figures, wherein:

FIG. 1 is a view illustrating an example of the configuration of an image forming system according to an exemplary embodiment;

FIG. 2 is a view illustrating the functional configuration of an image forming apparatus according to the exemplary embodiment;

FIG. 3 is a flow chart illustrating the flow of processes which are performed in the image forming apparatus;

FIG. 4 is a view illustrating an example of display of an UI when the process of STEP S101 is performed;

FIG. 5 is a view illustrating an example of a display screen in a preview display which is performed in STEP S102;

FIG. 6 is a view illustrating an example of a display screen which is displayed on the UI when printing parameters are set by a user for each individual content item; and

FIG. 7 is a view illustrating a display example in the preview display.

### DETAILED DESCRIPTION

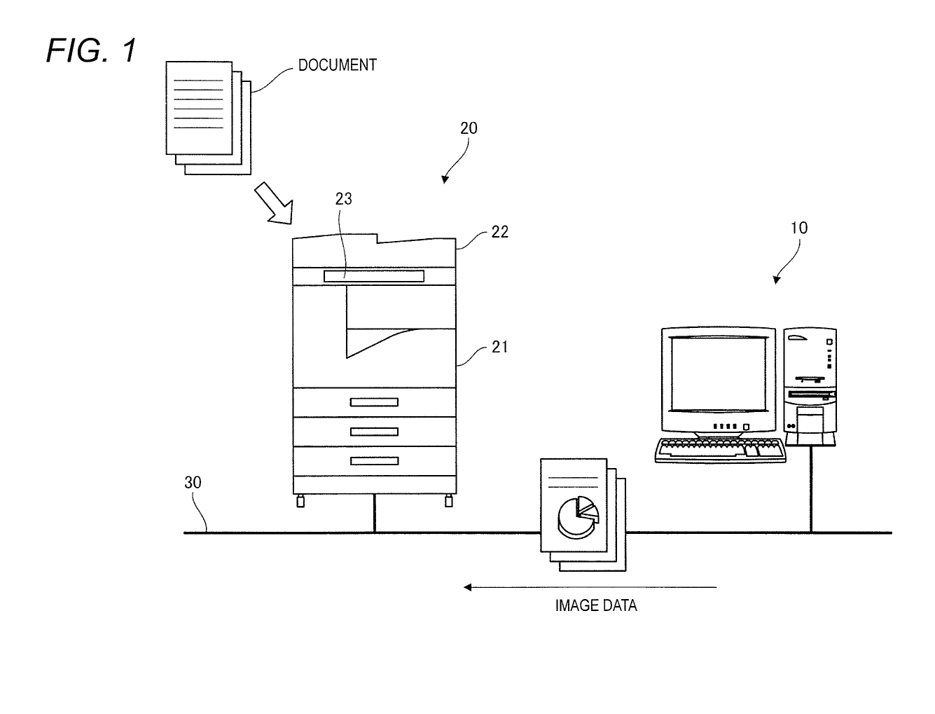

Hereinafter, exemplary embodiments of the present invention will be described in detail with reference to the accompanying drawings. FIG. 1 is a view illustrating an example of the configuration of an image forming system according to the exemplary embodiment. As shown in FIG. 1, the image forming system of the exemplary embodiment includes a terminal device 10 composed of a personal computer (PC), and an image forming apparatus 20 for performing image forming (printing) on sheets on the basis of image data which is transmitted from the terminal device 10 or image data which is acquired by an image reading device (to be described below). The terminal device 10 and the image forming apparatus 20 are connected to each other through a communication line 30. As the communication line 30, any one of wired communication lines and wireless communication lines may be used.

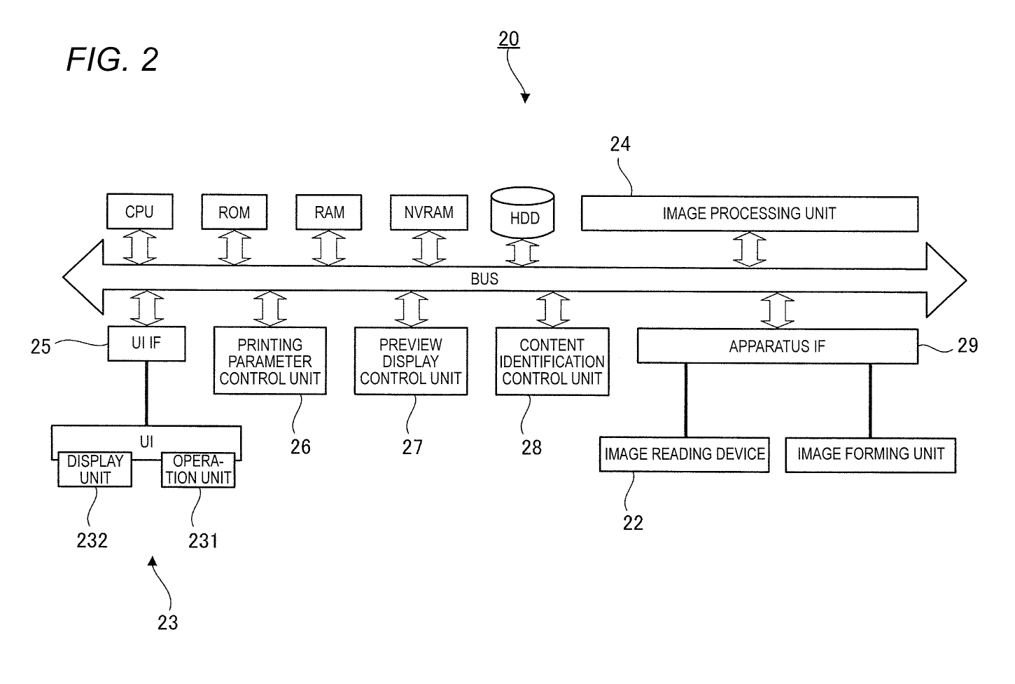

The image forming apparatus 20 as an example of a printing apparatus is provided with a main apparatus body 21. The main apparatus body 21 is provided therein with a sheet accommodating unit (not shown) for accommodating sheets as an example of recording medium, and an image forming unit (shown in FIG. 2) for forming images on sheets fed from the sheet accommodating units. The image forming apparatus 20 is provided with an image reading device (a scanner device) 22 for reading images on a document set by a user. Further, the image forming apparatus 20 is provided with a user interface (UI) 23, which displays information for the user and receives instructions from the user.

The image forming unit provided in the main apparatus body 21 may include a photosensitive drum, a charger for charging the photosensitive drum, a laser exposure unit for irradiating laser beams onto the photosensitive drum to form electrostatic latent image on the photosensitive drum, a developer for developing the electrostatic latent image formed on the photosensitive drum with toner, and a transfer unit for transferring toner image formed on the photosensitive drum to a sheet. In the exemplary embodiment, images are formed by an electrophotographic system. However, an ink-jet system or other systems may be used to form the images.

FIG. 2 is a view illustrating the functional configuration of the image forming apparatus 20. In addition to the above-explained configuration, the image forming apparatus 20 is provided with a CPU which performs main control of the image forming apparatus 20 and serves as a part of a printing instruction apparatus. The image forming apparatus 20 is provided with a ROM for storing programs and predetermined fixed data. A rewritable flash memory can be used as the ROM. The the image forming apparatus 20 is provided with a RAM which serves as a system memory during execution of a program, and serves as a page memory during image processing.

Further, the image forming apparatus 20 is provided with a NVRAM for storing parameters for adjusting image quality, history data, and so on. In the exemplary embodiment, functional units such as the CPU and the ROM are connected to one another through a bus. In the exemplary embodiment, the image forming apparatus 20 is provided with a HDD for storing image data, history data, and so on. The image forming apparatus 20 is provided with an image processing unit 24 for performing image data processing such as a process of compressing or decompressing image data. The image forming apparatus 20 is provided with an UI interface (IF) 25 which connects the UI 23 and the bus.

The UI 23 is provided with an operation unit 231 which is comprised of hard keys such as a start key, a stop key, and numerical keys, and is configured to be operated by the user. The UI 23 is provided with a display unit 232 which is composed of a liquid crystal monitor or the like for displaying information. In a case where the display unit 232 is composed of a touch panel type monitor, this monitor also serves as the operation unit 231.

The image forming apparatus 20 is provided with a printing parameter control unit 26 which performs setting and managing various parameters for printing (image forming). The image forming apparatus 20 is provided with a preview display control unit 27 which displays images based on image data for a printing process on the UI 23, before the printing process is performed. The image forming apparatus 20 is provided with a content identification control unit 28 which performs identifying and managing various contents included in the image data supplied for the printing process. In the exemplary embodiment, the image forming apparatus 20 is provided with an apparatus interface 29 for connecting the image reading device 22 and the image forming unit to the bus.

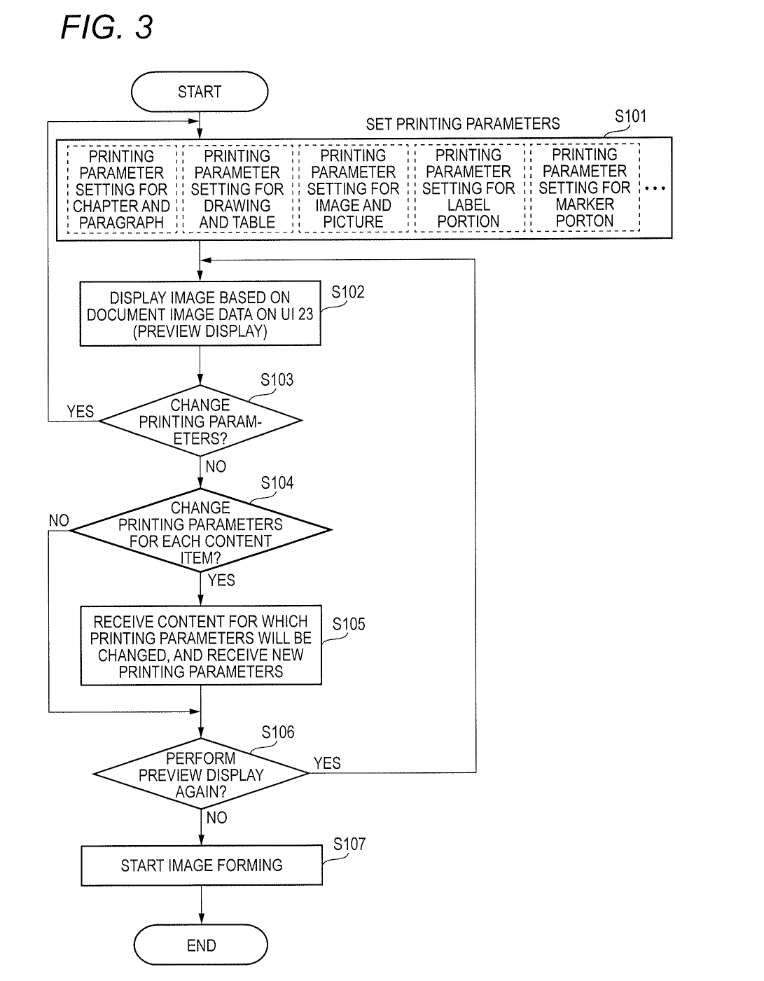

Next, the flow of processes which are performed in the exemplary embodiment will be described. FIG. 3 is a flow chart illustrating the flow of processes which are performed in the image forming apparatus 20. Here, the flow of processes to perform image forming on sheets on the basis of a result of reading of the image reading device 22 will be described as an example. In other words, the flow of processes in which a document set by the user is read by the image reading device 22 and the image forming is performed on sheets on the basis of the result of the reading of the document will be described.

In these processes, the image reading device 22 serving as an acquiring unit first operates and acquires image data (document data) relating to the document. The acquired image data is temporarily stored in the RAM. Then, before a printing process is performed, the printing parameter control unit 26 displays a reception screen for receiving printing parameters (printing conditions) from the user on the display unit 232 provided in the UI 23. Subsequently, in STEP S101, the reception screen is operated by the user and the setting of the printing parameters is performed.

In the exemplary embodiment, a plurality of printing parameters is prepared in advance such that the user can set printing parameters for each of the types of contents included in the image data (i.e. the image data of the document acquired by the image reading device 22: hereinafter, referred to as “document image data”) by operating the UI 23 serving as a part of a receiving unit.

Specifically, it is possible to perform setting of printing parameters for printing “CHAPTER” or “PARAGRAPH”, performing setting of printing parameters for printing “DRAWING” or “TABLE”, perform setting of printing parameters for printing “IMAGE” or “PICTURE”, perform setting of printing parameters for printing the label portions of images with “LABEL”, and perform setting of printing parameters for printing the marker portions of images colored by “MARKER”.

With those settings, in the exemplary embodiment, for example, it is possible to print less important “CHAPTER” or “PARAGRAPH” in a monochrome mode and a 4-in-1 mode (in which the images of four pages are gathered into one page). With respect to “DRAWING”, “TABLE”, and the like, it is possible to use colors and each full page for printing. In other words, in the exemplary embodiment, printing can be performed in view of the degree of importance and visibility.

Next, in the exemplary embodiment, the content identification control unit 28 analyzes the document image data stored in the RAM, thereby grasping contents included in the document image data. The content identification control unit 28 uses an existing technology for separating texts and images from each other, an existing technology regarding image matching, character recognition based on the OCT (Optical Character Recognition), and the like to grasp the contents included in the document image data.

Next, in STEP S102, the preview display control unit 27 serving as a part of a display displays an image based on the document image data on the display unit 232 in the UI 23. In other words, the preview display control unit 27 performs so-called preview display on the display unit 232 of the UI 23. When performing the preview display, the preview display control unit 27 performs the preview display, reflecting the printing parameters set by the user in STEP S101.

Specifically, when performing the preview display, the preview display control unit 27 first acquires the result of the grasping of the content identification control unit 28, thereby grasping the contents included in the document image data.

Then, when displaying each content item of the document image data on the UI 23, the preview display control unit 27 reflects the printing parameters set by the user for each of the types of the contents. In other words, when displaying the document image data on the UI 23, the preview display control unit 27 grasps the printing parameters set by the user for each of the types of the contents, and reflects the grasped printing parameters to display the document image data on the UI 23.

Next, in the exemplary embodiment, in STEP S103, the printing parameter control unit 26 displays a predetermined inquiry screen on the UI 23, thereby inquiring of the user about whether to change (reset) the printing parameters. If the user answers that the user will change the printing parameters, the processes of STEPS S101 and S102 are performed again. As a result, an image reflecting the changed (reset) printing parameters is displayed on the UI 23 again. In the exemplary embodiment, it is possible to change the printing parameters any number of times by repeating the processes of STEPS S101 to S103.

If the user answers the inquiry conducted in STEP S103 that the user will not change the printing parameters (i.e. change the printing parameters collectively for each of the types of the contents), in STEP S104, the printing parameter control unit 26 inquires of the user about whether to change the printing parameters for each individual content item.

If the user answers that the user will change the printing parameters for each individual content item, through the UI 23, in STEP S105, the printing parameter control unit 26 receives designation of a content item for which printing parameters are desired to be changed, from the user through the UI 23, and receives new printing parameters to be applied to the designated content item, from the user. In this way, in the exemplary embodiment, it is possible for the user to perform setting in more detail. For example, it is possible to set “MONOCHROME” and “4-IN-1” for an N-th chapter, to set “COLOR” and “2-IN-1” for an M-th paragraph, and to set “COLOR” and “1-IN-1” for an L-th drawing.

If the user answers the inquiry of STEP S104 (the inquiry on whether to change the printing parameters for each individual content item) that the user will not change the printing parameters, the process proceeds to STEP S106, not to STEP S105. In the exemplary embodiment, in STEP S106, the preview display control unit 27 displays a predetermined inquiry screen on the display unit 232 of the UI 23, thereby inquiring about whether to perform preview display again.

Then, if the user answers that the user will perform preview display through the UI 23, the processes of STEP S102 and the subsequent STEPS are performed again. If the setting of the printing parameters for each individual content item is performed (the process of STEP S105 is performed) and then the preview display is performed in STEP S102, the UI 23 displays an image reflecting both the printing parameters correctively set by the user for each of the types and the printing parameters individually set by the user for each individual content item.

Meanwhile, if the user does not answer the inquiry on whether to perform preview display again (the inquiry conducted in STEP S106) that the user will perform preview display, the printing parameter control unit 26 serving as a setting unit performs printing setting with respect to the document image data on the basis of the printing parameters set by the user. In other words, the printing parameter control unit 26 associates the document image data with the printing parameters set by the user.

Next, in the exemplary embodiment, the CPU serving as an instructing unit instructs each of functional units such as the image forming unit (shown in FIG. 2) serving as a printing mechanism to start printing (image forming) based on the document image data subjected to the printing setting. Therefore, the document image data subjected to the printing setting is output to the image forming unit (i.e. the document image data with information on the printing setting is output to the image forming unit), and the image forming unit starts image forming in STEP S107. As a result, in the exemplary embodiment, image forming on the sheets is performed reflecting the printing parameters set by the user (the printing parameters collectively set for each of the types of contents, and the printing parameters individually set by the user).

The setting of the printing parameters can be performed for each of the pages. However, in this case, it becomes difficult to perform setting in detail, and it becomes difficult to perform setting reflecting the intention of the user. If the printing parameters are individually set for each of the content items, it becomes possible to reflect the intention of the user. However, in this case, it takes much time to set the printing parameters.

If the printing parameters can be set for each of the types of contents as the exemplary embodiment, the intention of the user can be reflected as compared with the case of setting the printing parameters for each of the pages. Also, if the printing parameters can be set for each of the types of contents as the exemplary embodiment, it takes less time to set the printing parameters, as compared with the case of setting the printing parameters for each individual content items (i.e. as compared with a case of always setting the printing parameters for each individual content items).

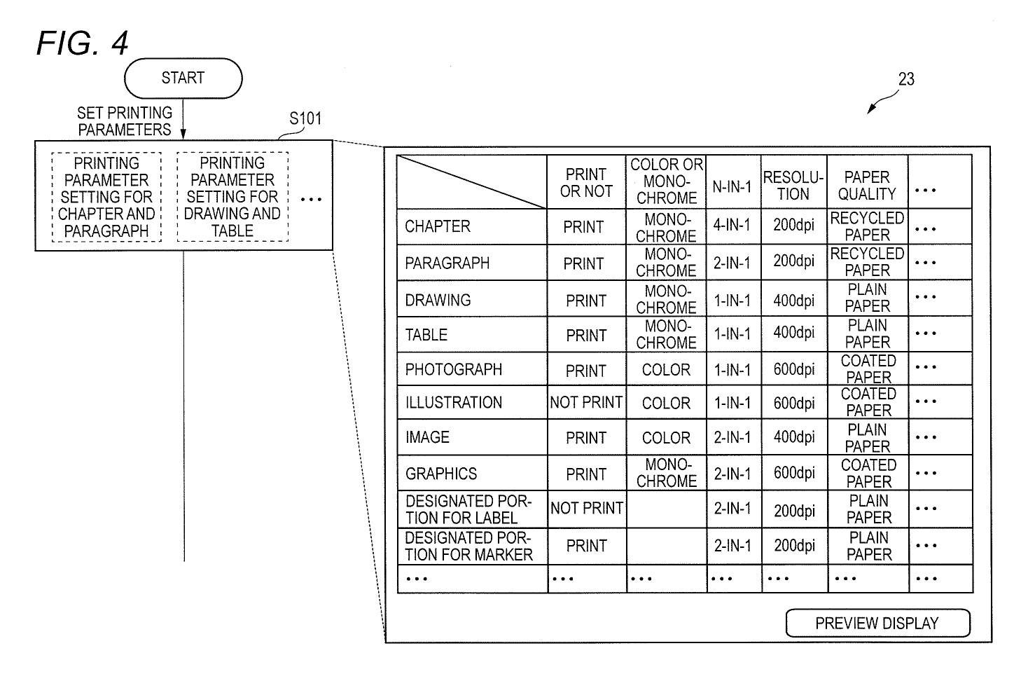

Now, the above-mentioned processes will be further described using a specific example. FIG. 4 is a view illustrating a display example of the UI 23 when the process of STEP S101 is performed. In other words, FIG. 4 is a view illustrating a display screen which is displayed on the UI 23 when the printing parameters are set for each of the types of the contents.

In STEP S101, as shown in FIG. 4, a matrix-like table is displayed on the UI 23. In this table, in a first column, a plurality of content types are displayed. Specifically, “CHAPTER”, “PARAGRAPH”, “DRAWING”, “TABLE”, “PICTURE”, “ILLUSTRATION”, “IMAGE”, “GRAPHICS”, “DESIGNATED PORTION FOR LABEL”, and “DESIGNATED PORTION FOR MARKER” are displayed. In this example, in a first row, a plurality of printing parameters are displayed. Specifically, printing parameters “PRINT OR NOT”, “COLOR OR MONOCHROME”, “N-IN-1” (to gather images of N-number of pages into one page), “RESOLUTION”, “SHEET QUALITY”, and so on are displayed.

Then, in the exemplary embodiment, the user can set the printing parameters by operating the matrix-like table displayed on the UI 23 (by touching the display screen on the UI 23). Specifically, the user can press (select) any one of a plurality of rectangular areas arranged in a matrix. As a result, a pull-down menu is displayed such that a plurality of options is displayed. Then, the user can select one from the plurality of options, thereby setting (changing) a corresponding printing parameter.

More specifically, for example, the user can perform an operation with respect to the type “DRAWING”, thereby setting the printing parameters “PRINT OR NOT” indicating whether to print “DRAWING” or not, “COLOR OR MONOCHROME” indicating whether to print “DRAWING” in color or in monochrome, “N-IN-1” indicating the number of “DRAWING” to be included in one page, “RESOLUTION” indicating the resolution for image forming of “DRAWING”, or “SHEET QUALITY” indicating the quality of sheets for image forming of “DRAWING”.

In the exemplary embodiment, as described in reference to STEP S102, the preview display is performed after the printing parameters are set. This preview display may be performed if the user pushes a press button “PREVIEW DISPLAY” shown in FIG. 4. In other word, if the user pushes the press button “PREVIEW DISPLAY” shown in FIG. 4, the process proceeds to STEP S102.

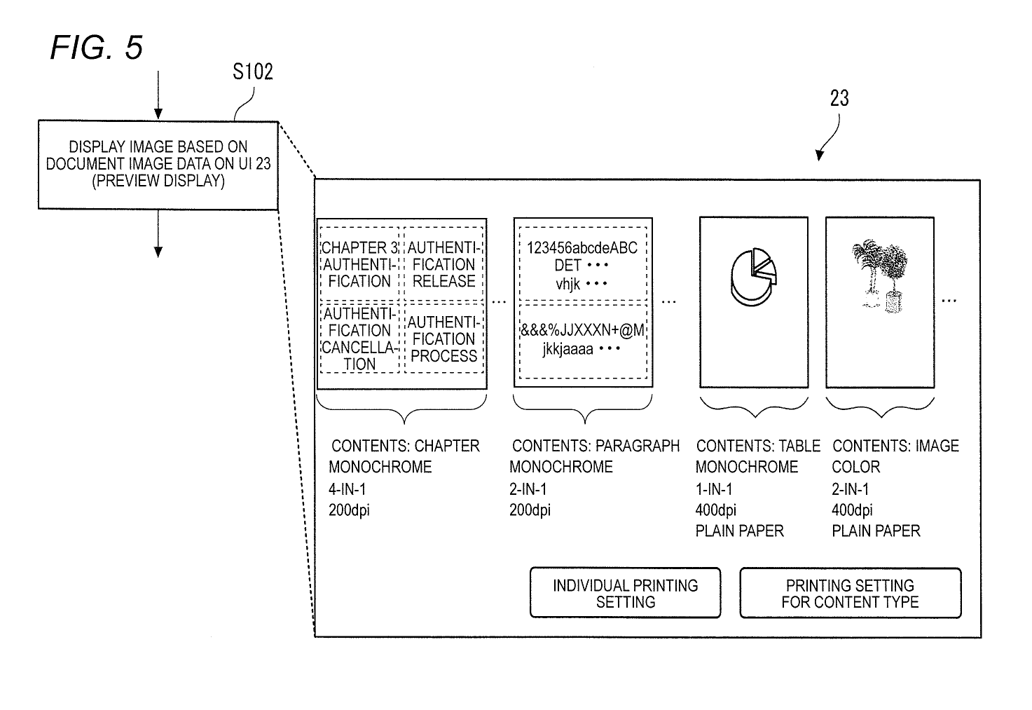

FIG. 5 is a view illustrating an example of a display screen in the preview display which is performed in STEP S102. As described above, in the exemplary embodiment, after the printing parameters are set, display based on the document image data is performed on the UI 23. At this time, the display is performed reflecting the printing parameters set by the user.

In the example shown in FIG. 5, with respect to the type “CHAPTER”, the printing parameters “MONOCHROME”, “4-IN-1”, and “200 dpi” are set. Also, with respect to the type “PARAGRAPH” constituting “CHAPTER”, the printing parameters “MONOCHROME”, “2-IN-1”, and “200 dpi” are set. Further, with respect to the type “TABLE”, the printing parameters “MONOCHROME”, “1-IN-1”, “400 dpi”, and “PLAIN PAPER” are set. In addition, with respect to the type “IMAGE”, the printing parameters “COLOR”, “2-IN-1”, “400 dpi”, and “PLAIN PAPER” are set.

In the display screen shown in FIG. 5, at the bottom right of the screen, a press button (“INDIVIDUAL PRINTING SETTING” shown in FIG. 5) which the user can push to change (reset) the printing parameters for each individual content item is displayed. If this press button is pushed, the process proceeds to STEP S105 described above.

In the display screen shown in FIG. 5, at the bottom right of the screen, a press button (“PRINTING SETTING FOR CONTENT TYPE” shown in FIG. 5) which the user can push to change (reset) the printing parameters for each of the types of the contents. If this press button is pushed, the process proceeds to STEPS S101 and S102 again.

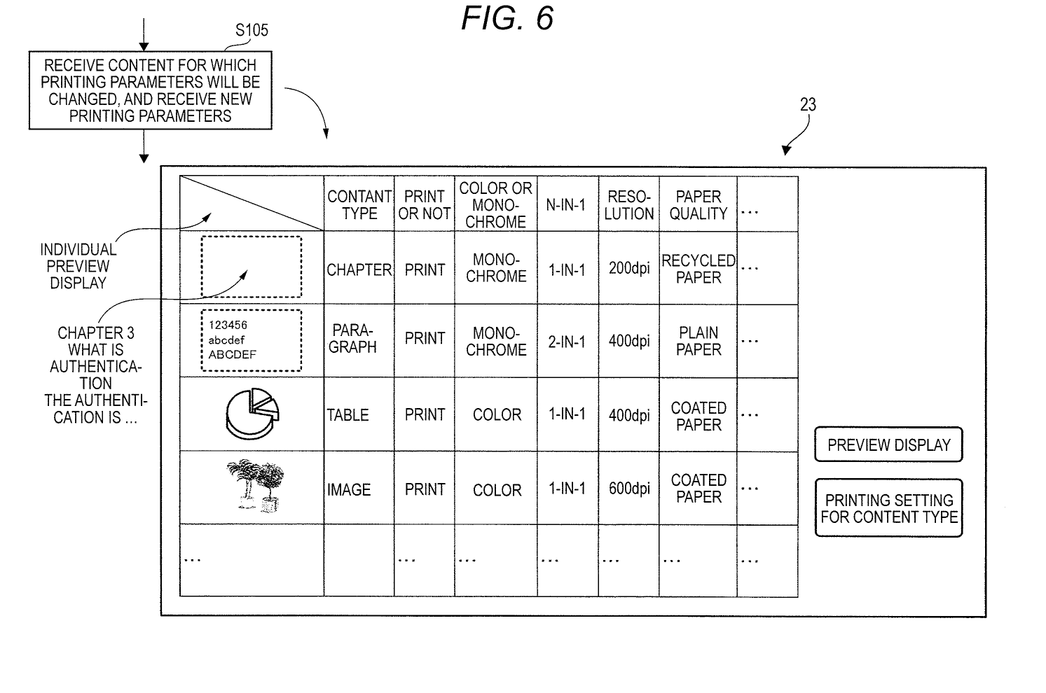

FIG. 6 is a view illustrating an example of a display screen which is displayed on the UI 23 when the printing parameters are set by the user for each individual content item. In other words, FIG. 6 is a view illustrating an example of a display screen which is displayed on the UI 23 when the process of STEP S105 is performed.

When the printing parameters are set for each individual content item, a matrix-like table shown in FIG. 6 is displayed on the UI 23. In this table, in the first column, individual contents are sequentially arranged. Specifically, a plurality of content items which the content identification control unit 28 has grasped by analyzing the document image data are displayed in the first column.

When the printing parameters are set for each individual content item, as described above, a plurality of printing parameters are displayed in a row. Then, when the process of STEP S105 is performed (the printing parameters are individually set for each content item), as described above, the user can push (select) any one of a plurality of rectangular areas arranged in a matrix. As a result, a pull-down menu is displayed such that a plurality of options is displayed. Then, the user can select one from the plurality of options, thereby setting (changing) a corresponding printing parameter.

Also, in the example shown in FIG. 6, it is possible to change the printing parameters with respect to a portion of “CHAPTER 3” in the document (a portion of Chapter 3 of a plurality of chapters included in the document), a portion starting with “123 . . . ” (a portion of a paragraph starting with “123 . . . ” among a plurality of paragraphs included in the document), a portion of a pie chart portion included in the document, and a portion of an image showing plants.

More specifically, in the exemplary embodiment, it is possible to change the printing parameters for each of “CHAPTER”, “PARAGRAPH”, “TABLE”, “IMAGE”, and the like. In the example shown in FIG. 6, a portion of “CHAPTER”, a portion of “PARAGRAPH”, a portion of “GRAPHICS”, and a portion of “IMAGE” are displayed, and it is possible to change the printing parameters with respect to them.

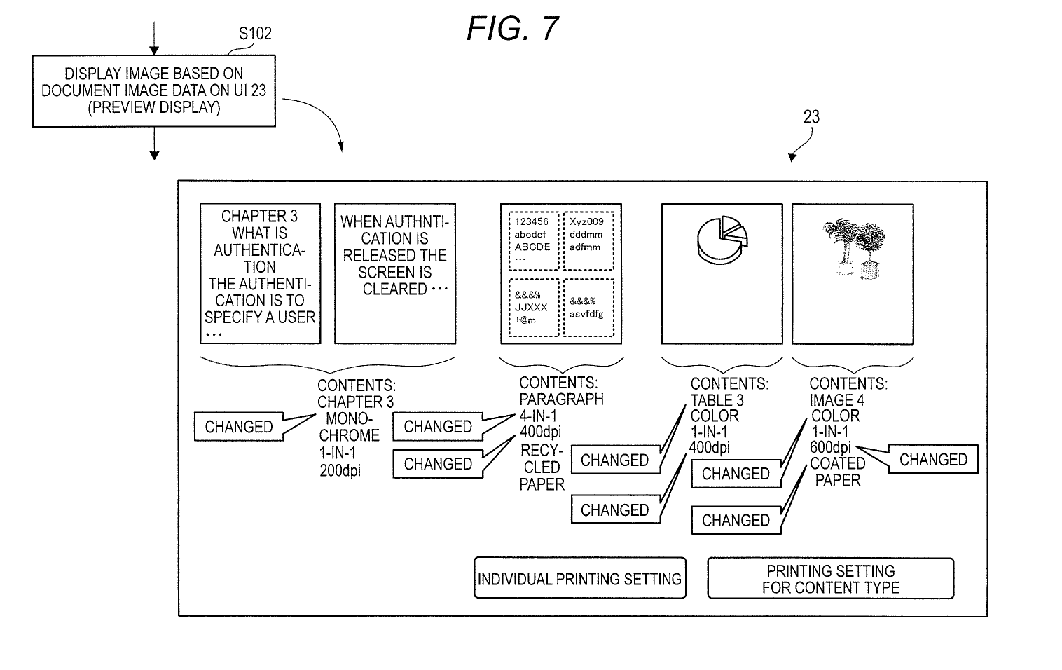

Also, in the display screen shown in FIG. 6, at the bottom right of the display screen, a display button (“PREVIEW DISPLAY” shown in FIG. 6) which the user can push to perform preview display is displayed. If this display button is pushed by the user, the process of STEP S102 described above is performed such that the preview display is performed again. In other words, a screen shown in FIG. 7 (which is a view illustrating an example of display in the preview display) is displayed on the UI 23.

Also, in the display screen shown in FIG. 6, at the bottom right of the display screen, a press button (“PRINTING SETTING FOR CONTENT TYPE” shown in FIG. 6) which the user can push to change (reset) the printing parameters for each of the types of the contents. If this press button is pushed, the process of STEP S101 described above is performed again. In other words, the screen shown in FIG. 4 is displayed again. Therefore, the user can cancel the setting of the printing parameters for each individual content item, and the user can set collectively the printing parameters for each of the types of the contents again.

Next, preview display shown in FIG. 7 will be described. In the preview display shown in FIG. 7, display similar to the preview display shown in FIG. 5 is performed. However, with respect to printing parameters re-changed (reset) (printing parameters individually set for each content item) by the user, in order to clarify that the corresponding printing parameters have been re-changed, as shown in FIG. 7, display indicating that the corresponding printing parameters have been changed is performed.

In other words, in the exemplary embodiment, if the user individually sets any one of the printing parameters for each content item, some of the printing parameters that have been collectively set for each of the types of the contents may be changed. In this case, in the exemplary embodiment, information on those changes is notified to the user by the UI 23 serving as a notifying unit. Therefore, it becomes easy for the user to recognize the changes of the printing parameters performed by the user.

Also, when the preview display shown in FIG. 7 is performed, each content item in which printing parameters have individually changed by the user may be displayed in larger scale. For example, in a case where the user has changed any printing parameter with respect to a content item “FIG. 1” (not shown), the content item “FIG. 1” may be displayed in larger scale. In this case, it becomes easier for the user to recognize the changes of the printing parameters performed by the user.

Also, in the display screen shown in FIG. 7, at the bottom right of the screen, a press button (“PRINTING SETTING FOR CONTENT TYPE” shown in FIG. 7) which is used to inquire about whether to collectively change the printing parameters for each of the types of the contents is displayed. If this press button is pushed by the user, in the exemplary embodiment, the process of STEP S101 described above is performed again.

Also, in the display screen shown in FIG. 7, at the bottom right of the screen, another press button (“INDIVIDUAL PRINTING SETTING FOR EACH CONTENT ITEM” shown in FIG. 7) which is used to inquire about whether to change the printing parameters for each individual content item is displayed. If this press button is pushed, in the exemplary embodiment, the process of STEP S105 described above is performed such that the screen shown in FIG. 6 is displayed again.

Although the processes which are performed in the image forming apparatus 20 have been described, each of the above-mentioned processes may be performed in the terminal device 10. Specifically, the user may operate the terminal device 10, thereby collectively setting the printing parameters for each of the types of the contents included in the image data (the document data) or individually setting the printing parameters for each content item. After the setting of the printing parameters terminates, the terminal device 10 may transmit the image data to the image forming apparatus 20, and the image forming apparatus 20 may perform a printing process.

Also, a program for implementing the above-mentioned processes may be installed in the terminal device 10 or the image forming apparatus 20 to be supplied to a customer or a user, or may be computer-readably stored in a recording medium or the like to be supplied to a customer or a user. This recording medium corresponds to, for example, a CD-ROM medium or the like which the above-mentioned program can be read by a CD-ROM reading apparatus (not shown) such that the program can be executed. Also, the above-mentioned program may be supplied through a network, for example, by program transmitting devices (not shown).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printing instruction apparatus comprising:
an acquiring unit that acquires document data of a document to be printed;
a receiving unit that receives printing conditions set by a user for each of types of document components included in the document;
a setting unit that performs printing setting for each of the types of the document components with respect to the document data acquired by the acquiring unit, in response to a reception of the printing conditions by the receiving unit; and
an instructing unit that instructs a printing mechanism to perform printing based on the document data subjected to the printing setting by the setting unit.

2. The printing instruction apparatus according to claim 1,
wherein the receiving unit is configured to receive the printing conditions set by the user individually for each of the plurality of document components included in the document, and
wherein when performing the printing setting with respect to the document data acquired by the acquiring unit, the setting unit performs the printing setting for each of the types of the document components while performing the printing setting for each of the documents components for which the printing conditions is set by the user in individually.

3. The printing instruction apparatus according to claim 1, further comprising a display that displays an image which is based on the document data and reflects the printing setting for each of the types of the document components, before the printing based on the document data is started by the printing mechanism.

4. The printing instruction apparatus according to claim 2, further comprising a display that displays an image which is based on the document data, reflects the printing setting for each of the types of the document components, and reflects the printing setting for each of the document components, before the printing based on the document data is started by the printing mechanism.

5. The printing instruction apparatus according to claim 2,
wherein the printing setting of the printing conditions for each of the types of the document components by the user is performed before the printing setting of the printing conditions for each of the document components by the user, and
wherein the printing instruction apparatus further includes a notifying unit that when the printing setting of the printing conditions for each of the document components by the user causes a change in a portion of the printing conditions set for each of the types of the document components, notifies the user of information regarding the change.

6. A printing apparatus comprising:
an acquiring unit that acquires document data of a document to be printed;
a receiving unit that receives printing conditions set by a user for each of the types of document components included in the document;
a setting unit that performs printing setting for each of the types of the document components with respect to the document data acquired by the acquiring unit, in response to a reception of the printing conditions by the receiving unit; and
a printing mechanism that performs printing on recording medium based on the document data subjected to the printing setting by the setting unit.

7. A printing instruction method, comprising:
receiving printing conditions set by a user for each of types of documents components included in a document to be printed;
performing printing setting for each of the type of the document components with respect to document data of the document, in response to a reception of the printing conditions; and
instructing a printing mechanism to perform printing based on the document data subjected by the printing setting.

8. A non-transitory computer readable medium storing a program causing a computer to execute a printing instruction method comprising:
receiving printing conditions set by a user for each of types of documents components included in a document to be printed;
performing printing setting for each of the type of the document components with respect to document data of the document, in response to a reception of the printing conditions; and
instructing a printing mechanism to perform printing based on the document data subjected by the printing setting.
